(19) United States
(12) Patent Application Publication
(10) Pub. No.: US 2015/0151750 A1
(43) Pub. Date: Jun. 4, 2015

(54) VEHICLE BEHAVIOR CONTROL DEVICE AND VEHICLE BEHAVIOR CONTROL SYSTEM

(71) Applicant: TOYOTA JIDOSHA KABUSHIKI KAISHA, Toyota-shi (JP)

(72) Inventors: Yoshiaki TSUCHIYA, Miyoshi-shi (JP); Hiroshi ISHIGURO, Kariya-shi (JP); Tatsuya YOSHIKAWA, Anjo-shi (JP)

(73) Assignee: TOYOTA JIDOSHA KABUSHIKI KAISHA, Toyota-shi (JP)

(21) Appl. No.: 14/554,166

(22) Filed: Nov. 26, 2014

(30) Foreign Application Priority Data
Nov. 29, 2013 (JP) 2013-247799

(51) Int. Cl. B60W 30/09; B60W 10/20; B60W 10/18

(52) U.S. Cl. CPC B60W 30/09; B60W 10/18; B60W 10/20

(57) ABSTRACT

A vehicle behavior control device includes a collision determining unit configured to determine whether a vehicle collides with an obstacle at a time the vehicle is decelerated while traveling straight, based on a detection result of the obstacle in front of the vehicle and a detection result of a traveling state of the vehicle, in a state in which wheels are braked; and a vehicle behavior control unit configured to perform any of a first detour mode in which control over steering of rear wheels is performed and control of providing a difference in a braking state of left and right wheels is not performed and a second detour mode in which the control over steering of the rear wheels and the control of providing the difference in the braking state of the left and right wheels are performed such that the vehicle is decelerated while detouring the obstacle.

### CROSS-REFERENCE TO RELATED APPLICATIONS

The present application claims priority to and incorporates by reference the entire contents of Japanese Patent Application No. 2013-247799 filed in Japan on Nov. 29, 2013.

### BACKGROUND OF THE INVENTION

1. Field of the Invention

Embodiments of the present invention relate to a vehicle behavior control device and a vehicle behavior control system.

2. Description of the Related Art

Conventionally, technologies for avoiding collision with obstacles under the control of braking or steering described in Japanese Patent Application Laid-open No. 2011-152884 and Japanese Patent Application Laid-open No. 2002-293173 are known.

In such types of technologies, it is preferable to allow the collision or contact with the obstacles to be more effectively avoided by appropriately controlling the braking or the steering.

### SUMMARY OF THE INVENTION

It is an object of the present invention to at least partially solve the problems in the conventional technology.

According to one aspect of the present embodiment, a vehicle behavior control device includes a collision determining unit configured to determine whether or not a vehicle collides with an obstacle at a time the vehicle is decelerated while traveling straight, based on a detection result of the obstacle in front of the vehicle and a detection result of a traveling state of the vehicle, in a state in which wheels are braked; and a vehicle behavior control unit configured to perform any of a first detour mode in which control over steering of rear wheels is performed and control of providing a difference in a braking state of left and right wheels is not performed and a second detour mode in which the control over steering of the rear wheels and the control of providing the difference in the braking state of the left and right wheels are performed such that the vehicle is decelerated while detouring the obstacle, at a time it is determined by the collision determining unit that the vehicle collides with the obstacle. Therefore, according to the present embodiment, as an example, the collision or contact with the obstacles is more effectively avoided with ease using the first detour mode in which a braking distance is relatively short and the second detour mode in which a transverse movement distance is greater.

According to another aspect of the present embodiment, in the vehicle behavior control device, the vehicle behavior control unit selects and performs any one of the first detour mode and the second detour mode based on the detection result of the traveling state of the vehicle. Therefore, as an example, the collision or contact with the obstacles is more effectively avoided with ease by selecting the detour mode corresponding to situations.

According to still another aspect of the present embodiment, the vehicle behavior control device further includes a detour path calculating unit configured to calculate a path of the vehicle at a time the vehicle is decelerated while detouring the obstacle, wherein the vehicle behavior control unit performs control according to the second detour mode when the vehicle does not detour the obstacle on a path that is calculated by the detour path calculating unit and is caused by the first detour mode. Therefore, as an example, the braking distance is further shortened with ease.

According to still another aspect of the present embodiment, in the vehicle behavior control device, at a time the detected obstacle is located at one side relative to a base line offset from a central line, which extends through a vehicle width direction center of the vehicle in a forward/backward direction of the vehicle, toward a driver's seat by a given distance, the vehicle behavior control unit controls the vehicle to detour the obstacle to the other side, and at a time the detected obstacle is located at the other side relative to the base line, the vehicle behavior control unit controls the vehicle to detour the obstacle to one side. Therefore, as an example, the vehicle easily makes a detour in a direction accepted in an easier way by a driver.

According to still another aspect of the present embodiment, a vehicle behavior control system includes a data acquiring unit configured to acquire underlying data for detecting an obstacle in front of a vehicle; a steering device for rear wheels; a braking device for each wheel; and a control device configured to have a collision determining unit that determines whether or not the vehicle collides with the obstacle at a time the vehicle is decelerated while traveling straight, based on a detection result of the obstacle in front of the vehicle and a detection result of a traveling state of the vehicle, in a state in which the wheels are braked, and a vehicle behavior control unit that performs any of a first detour mode in which control over steering of the rear wheels is performed and control of providing a difference in a braking state of left and right wheels is not performed and a second detour mode in which the control over steering of the rear wheels and the control of providing the difference in the braking state of the left and right wheels are performed such that the vehicle is decelerated while detouring the obstacle, at a time it is determined by the collision determining unit that the vehicle collides with the obstacle. Therefore, as an example, the collision or contact with the obstacles is more effectively avoided with ease using the first detour mode in which the braking distance is relatively short and the second detour mode in which the transverse movement distance is greater.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram in which a schematic configuration of an example of a vehicle behavior control system of an embodiment is illustrated;

FIG. 2 is a functional block diagram of a vehicle behavior control device in the example of the vehicle behavior control system of the embodiment;

FIG. 3 is a flowchart in which an example of a control method based on the vehicle behavior control system of the embodiment is illustrated;

FIG. 4 is a schematic diagram (overhead view) in which an example of a state in which the vehicle behavior control system of the embodiment determines that a vehicle collides with an obstacle when the vehicle is decelerated while traveling straight is illustrated;

FIG. 5 is a schematic diagram (overhead view) in which an example of a behavior of the vehicle controlled by the vehicle behavior control system of the embodiment is illustrated;

FIG. 6 is a flowchart (a part of the flowchart of FIG. 3) in which an example of a method of determining whether or not to collide with an obstacle according to the vehicle behavior control system of the embodiment is illustrated;

FIG. 7 is a graph in which an example of a time-dependent change of each parameter in the vehicle behavior control system of the embodiment is illustrated;

FIG. 8 is a graph in which an example of a correlation between a hydraulic pressure value set at the vehicle behavior control system of the embodiment and a road surface friction coefficient is illustrated;

FIG. 9 is a graph in which an example of a correlation between a vehicle speed in the vehicle behavior control system of the embodiment and a transverse movement distance is illustrated;

FIG. 10 is a schematic diagram illustrating decision of a detour direction in the vehicle behavior control system of the embodiment;

FIG. 11 is a flowchart (a part of the flowchart of FIG. 3) in which an example of a method of deciding the detour direction and a detour mode in the vehicle behavior control system of the embodiment is illustrated;

FIG. 12 is a graph in which an example of control time setting performing control of detour and deceleration corresponding to the vehicle speed at the vehicle behavior control system of the embodiment is illustrated; and

FIG. 13 is a graph in which an example of a yaw rate against a steering speed of rear wheels at the vehicle behavior control system of the embodiment is illustrated with respect to multiple vehicle speeds.

### DETAILED DESCRIPTION OF THE PREFERRED EMBODIMENTS

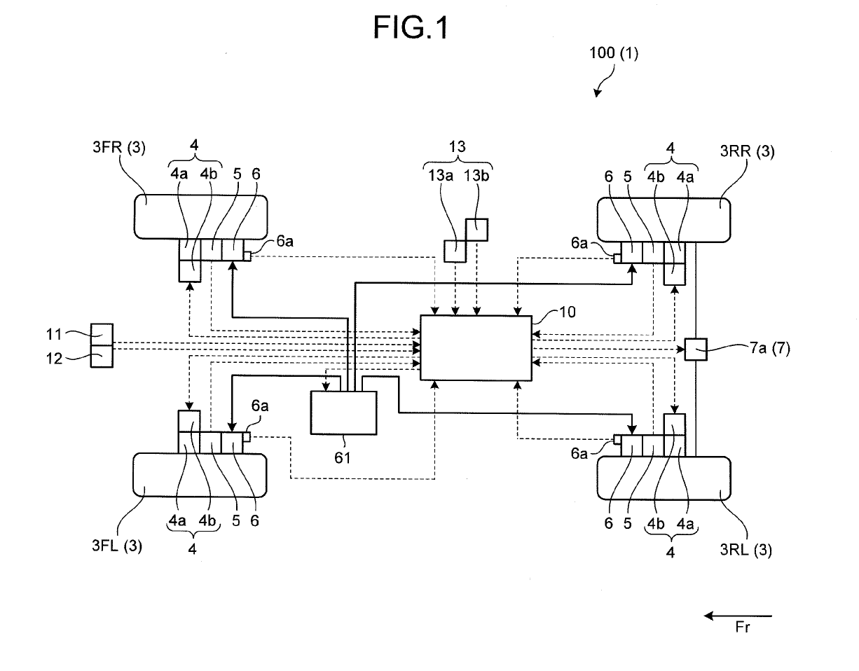

In the present embodiment, a vehicle 1 may be, for instance, a vehicle (an internal combustion engine vehicle) using an internal combustion engine (an engine, not illustrated) as a drive source, a vehicle (an electric vehicle, a fuel cell vehicle, and the like) using an electric motor (a motor, not illustrated) as a drive source, or a vehicle (a hybrid vehicle) using both of them as a drive source. Further, the vehicle 1 can be mounted with various transmissions, and various devices (systems, units, and the like) required to drive the internal combustion engine and the electric motor. Further, a mode, number, and layout of a device associated with driving of wheels 3 in the vehicle 1 can be variously set. Further, in the present embodiment, as an example, the vehicle 1 is a four-wheeled car (four-wheeled vehicle) and has left and right two front wheels 3FL and 3FR and left and right two rear wheels 3RL and 3RR. In FIG. 1, a front side in a forward/backward direction (direction Fr) of the vehicle is a left side.

In the present embodiment, as an example, a vehicle behavior control system 100 (a collision avoidance control system or an automatic detour deceleration system) of the vehicle 1 includes a control device 10, an image pickup device 11, a radar device 12, acceleration sensors 13a and 13b (13), and a braking system 61. Further, the vehicle behavior control system 100 includes a suspension system 4, a rotation sensor 5, and a braking device 6 for each of the two front wheels 3FL and 3FR and the suspension system 4, the rotation sensor 5, the braking device 6, and a steering device 7 for each of the two rear wheels 3RL and 3RR. Further, in addition to FIG. 1, basic components functioning as the vehicle 1 are provided in the vehicle 1. However, only a configuration of the vehicle behavior control system 100 and control of the configuration will be described here.

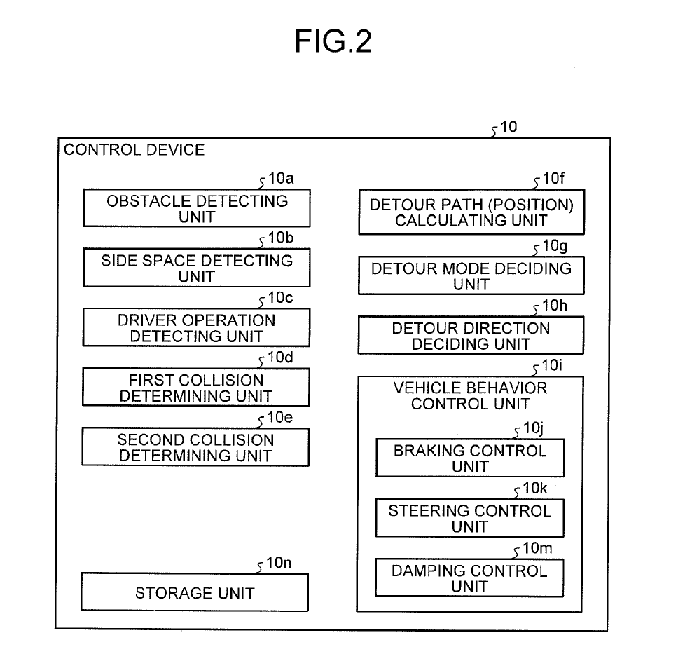

The control device (control unit) 10 receives a signal or data from each unit of the vehicle behavior control system 100, and controls each unit of the vehicle behavior control system 100. In the present embodiment, the control device 10 is an example of a vehicle behavior control device. Further, the control device 10 is configured as a computer, and includes an operation processing unit (a microcomputer, an electronic control unit (ECU), and the like, not illustrated) and a storage unit 10n (for instance, a read only memory (ROM), a random access memory (RAM), a flash memory, and the like, see FIG. 2). The operation processing unit reads out a program stored (installed) in the nonvolatile storage unit (for instance, the ROM, the flash memory, and the like) 10n, executes calculation according to the program, and can function (act) as each unit illustrated in FIG. 2. Further, data (a table (data group), a function, and the like) used for various calculations associated with the control and results of the calculation (also including values in the course of the calculation) can be stored in the storage unit 10n.

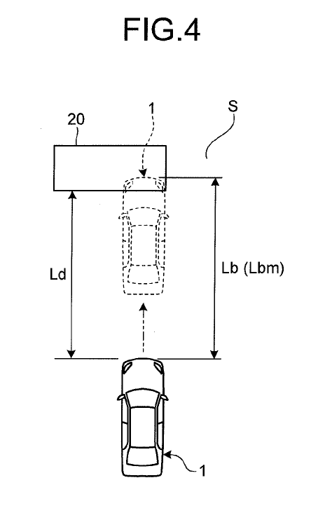

The image pickup device (image pickup unit) 11 is a digital camera in which an imaging element such as a charge coupled device (CCD) or a CMOS image sensor (CIS) is mounted. The image pickup device 11 can output image data (moving picture data or frame data) at a given frame rate. In the present embodiment, as an example, the image pickup device 11 is located, for instance, at an end (an end when viewed from the top) of the front side (the front side in the forward/backward direction of the vehicle) of a vehicle body (not illustrated), and can be provided for a front bumper, or the like. Thus, the image pickup device 11 outputs image data including an obstacle 20 in front of the vehicle 1 (see FIG. 4). The image data is an example of underlying data for detecting the obstacle 20. Further, the image pickup device 11 is an example of an obstacle detecting unit or a data acquiring unit.

The radar device (radar unit) 12 is, for instance, a millimeter-wave radar device. The radar device 12 can output distance data representing a separation distance Ld (a separation distance or a detection distance, see FIG. 4) up to the obstacle 20 or speed data representing a relative speed (speed) to the obstacle 20. The distance data or the speed data is an example of underlying data for detecting the obstacle 20. Further, the radar device 12 is an example of the obstacle detecting unit or the data acquiring unit. The control device 10 can update a result of measuring the separation distance Ld between the vehicle 1 and the obstacle 20 using the radar device 12 at any time (for instance, at a fixed time interval), store the updated result in the storage unit 10n, and use the updated result of measuring the separation distance Ld for the purpose of calculation.

The acceleration sensors 13 can detect acceleration of the vehicle 1. In the present embodiment, as an example, the vehicle 1 is provided with, as the acceleration sensors 13, the acceleration sensor 13a for obtaining acceleration in a forward/backward direction (a longitudinal direction) of the vehicle 1 and the acceleration sensor 13b for obtaining acceleration in a widthwise direction (a vehicle width direction, a transverse direction, or a leftward/rightward direction) of the vehicle 1.

The suspension system (suspension) 4 is interposed between the wheel 3 and the vehicle body (not illustrated), and inhibits vibrations or shocks from a road surface from being transmitted to the vehicle body. Further, in the present embodiment, as an example, the suspension system 4 has a shock absorber 4a that can electrically control (adjust) a damping characteristic. Therefore, the control device 10 can control an actuator 4b according to an instruction signal, and change (modify, convert, or variably set) the damping characteristic of the shock absorber 4a (suspension system 4). The suspension system 4 is provided for each of the four wheels 3 (the two front wheels 3FL and 3FR and the two rear wheels 3RL and 3RR). The control device 10 can control the damping characteristic of each of the four wheels 3. The control device 10 may control the four wheels 3 in a state in which the damping characteristics differ from one another.

The rotation sensor 5 (or the rotational speed sensor, the angular velocity sensor, the wheel sensor) can output a signal corresponding to a rotational speed (or an angular velocity, a rotating speed, a rotational state) of each of the four wheels 3. According to a detection result of the rotation sensor 5, the control device 10 can obtain a slip ratio of each of the four wheels 3 and determine whether or not each wheel is locked. Further, the control device 10 can also obtain a speed of the vehicle 1 from the detection result of the rotation sensor 5. Further, aside from the rotation sensors 5 for the wheels 3, a rotation sensor (not illustrated) for detecting rotation of a crankshaft or an axle may be provided, and the control device 10 may obtain the speed of the vehicle 1 from a detection result of this rotation sensor.

The braking device 6 (or the brake, the hydraulic system) is installed on each of the four wheels 3, and puts a brake on the corresponding wheel 3. In the present embodiment, as an example, the braking device 6 is controlled by the braking system 61. As an example, the braking system 61 may be configured as an anti-lock brake system (ABS).

The steering device 7 steers the rear wheels 3RL and 3RR. The control device 10 can control an actuator 7a depending on an instruction signal, and change (or modify, convert) a rudder angle (a turning angle or a steering angle) of the rear wheels 3RL and 3RR.

The configuration of the aforementioned vehicle behavior control system 100 is merely an example, and can be variously modified and carried out. Known devices may be used as individual devices constituting the vehicle behavior control system 100. Further, each configuration of the vehicle behavior control system 100 may be shared with other configurations. Furthermore, the vehicle behavior control system 100 may be equipped with a sonar device as an obstacle detecting unit or a data acquiring unit.

Meanwhile, in the present embodiment, as an example, the control device 10 may function (act) as an obstacle detecting unit 10a, a side space detecting unit 10b, a driver operation detecting unit 10c, a first collision determining unit 10d, a second collision determining unit 10e, a detour path (position) calculating unit 10f, a detour mode deciding unit 10g, a detour direction deciding unit 10h, a vehicle behavior control unit 10i, a braking control unit 10j, a steering control unit 10k, or a damping control unit 10m, as illustrated in FIG. 2, in cooperation with hardware and software (program). That is, the program may, as an example, include a module corresponding to each block except the storage unit 10n illustrated in FIG. 2.

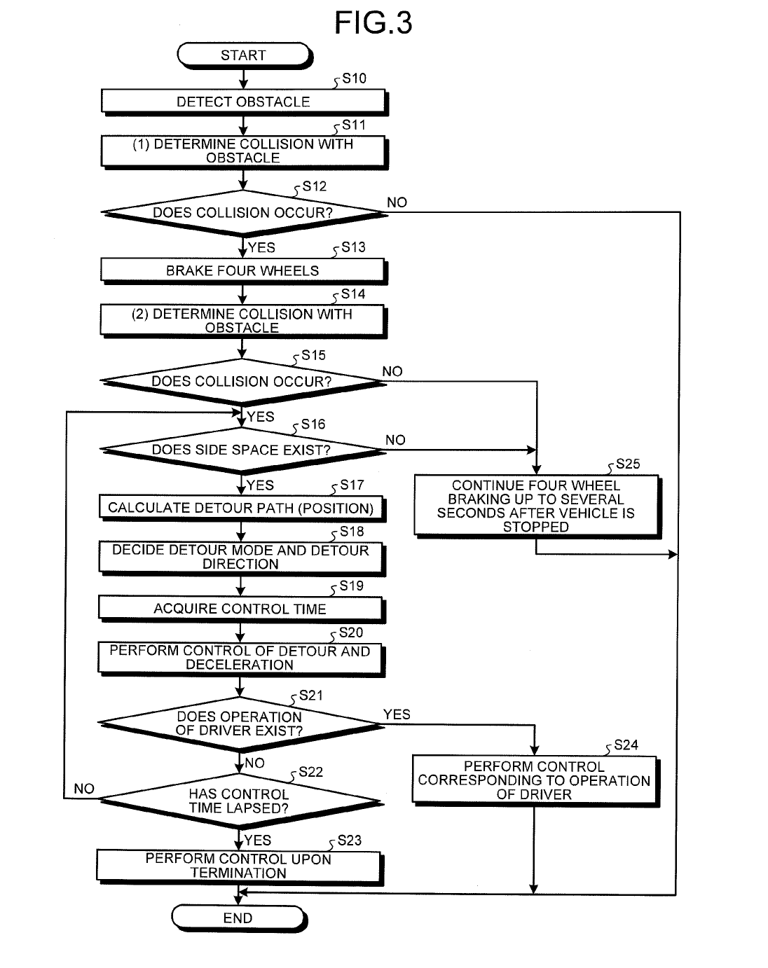

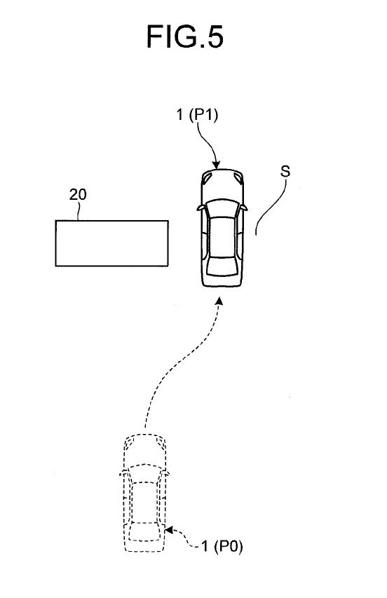

Then, the control device 10 of the present embodiment can, as an example, have control over detour and deceleration of the vehicle 1 in the procedure illustrated in FIG. 3. When it is predicted, as illustrated in FIG. 4, that the vehicle 1 collides with the obstacle 20 in front of the vehicle 1 if the vehicle 1 is decelerated while traveling straight, the control device 10 controls each unit of the vehicle 1 such that, as illustrated in FIG. 5, under condition that a space S to which the vehicle 1 can move (enter) is present at the side of the obstacle 20 (and no obstacle is detected from the space S), the vehicle 1 is decelerated while detouring (turning) the obstacle 20 toward the space S. However, when it is predicted that the vehicle 1 does not collide with the obstacle 20 even if the vehicle 1 is decelerated while traveling straight, the control device 10 controls the braking device 6 such that the vehicle 1 is decelerated while traveling straight. To be specific, first, the control device 10 functions as the obstacle detecting unit 10a, and detects the obstacle 20 (see FIG. 4) in front of the vehicle 1 (step S10). In step S10, with respect to the obstacle 20 consistent with a predetermined condition (for instance, a size), the control device 10 acquires a position (a separation distance Ld from the vehicle 1) of the obstacle 20 from data obtained from the image pickup device 11 or the radar device 12.

Next, the control device 10 functions as the first collision determining unit 10d and, when the vehicle 1 is decelerated (or undergoes braking control) while traveling straight, determines whether or not the vehicle 1 collides with the obstacle 20 detected in step S10 (step S11). In step S11, the control device 10 acquires, for instance, a speed of the vehicle 1 at the time of the collision, and acquires a braking distance Lb corresponding to the acquired speed of the vehicle 1 with reference to data (for instance, a table or a function) that represents a correspondence relation between a speed (vehicle speed) stored in the storage unit 10n (for instance, the ROM or the flash memory) and a braking distance Lb (a stopping distance or a movement distance required until the vehicle 1 is stopped when the vehicle 1 is decelerated (or undergoes braking control) while traveling straight, see FIG. 4) when maximum deceleration is generated. Then, the control device 10 compares the braking distance Lb with the separation distance Ld, and carries out step S13 when the braking distance Lb is equal to or longer (greater) than the separation distance Ld (Yes in step S12 or it is determined that the collision occurs (or that a chance to collide is present or high)). On the other hand, when the braking distance Lb is shorter (smaller) than the separation distance Ld (No in step S12 or it is determined that no collision occurs (or that a chance to collide is not present or low)), the control device 10 terminates a series of processes.

In step S13, the control device 10 functions as the braking control unit 10j, and controls the braking device 6 of each wheel 3 via the braking system 61 to brake the four wheels 3 (as an example, full braking).

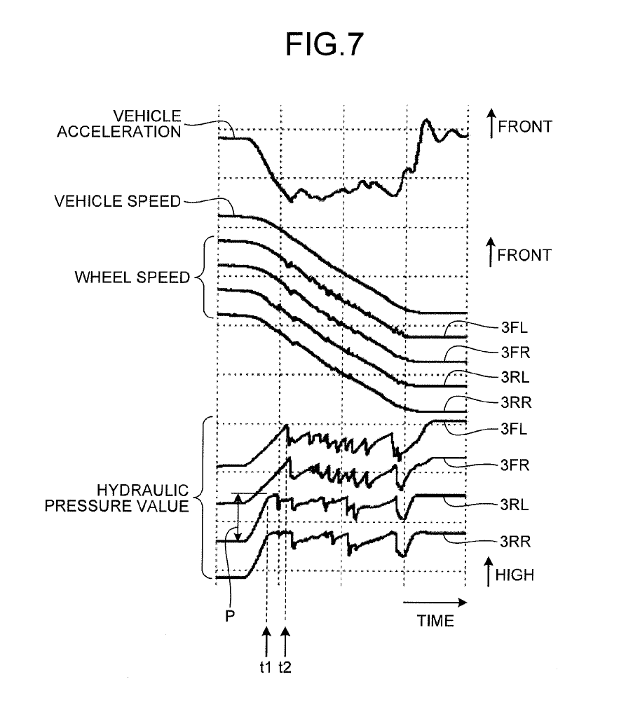

Subsequently, the control device 10 functions as the second collision determining unit 10e, and again determines whether or not to collide with the obstacle 20 when the vehicle 1 is decelerated (or undergoes braking control) in the straight traveling state (step S14). In step S14, the determination is carried out in a state in which the wheels 3 (in the present embodiment, as an example, the four wheels 3) are braked. That is, in step S14, the control device 10 reflects braking conditions (a rotational state of the wheels 3, a traveling condition of the vehicle 1, and a response of each unit to braking control input) of each of the four wheels 3 based on the braking control, and can more accurately determine whether or not the collision occurs. To be specific, in step S14, the second collision determining unit 10e detects a first lock state (initiation of a slip) caused by braking each wheel 3 (step S141). The lock state caused by braking the wheel 3 can be detected by, for instance, a detection result (a hydraulic pressure value of a caliper) of a hydraulic sensor 6a of the braking device 6. As exemplified in FIG. 7, the detection result of the hydraulic sensor 6a continues to be raised by braking of the braking device (ABS) 6 until each wheel 3 is locked, and reaches a peak when the wheel 3 is locked and then is lowered, or is subjected to a decrease in a rate of rise (a rate of change or a time differential value) per unit time of the detection result. Therefore, due to a time-dependent change in the detection result of the hydraulic sensor 6a corresponding to each wheel 3, it can be detected, for instance, by comparison of the time differential value and a given threshold value that the wheel 3 is locked. In FIG. 7, a time-dependent change in forward/backward acceleration of the vehicle 1, a time-dependent change in speed (vehicle speed) of the vehicle 1, and a time-dependent change in wheel speed of each wheel 3 (the front wheels 3FL and 3FR and the rear wheels 3RL and 3RR) are also illustrated. Further, the hydraulic sensor 6a may be provided at an arbitrary place at which a hydraulic pressure changed in conjunction (correspondence) with a hydraulic pressure at the braking device (caliper) 6 of each wheel 3 can be detected.

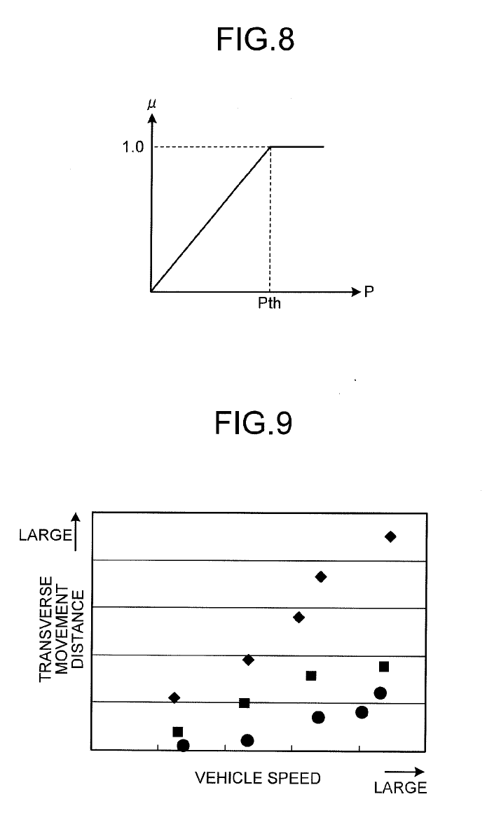

Next, when the lock state of the wheel 3 is detected (Yes in step S142), the second collision determining unit 10e acquires a parameter corresponding to a road surface friction coefficient (step S143). In step S143, for instance, the parameter corresponding to the road surface friction coefficient is the detection result (the hydraulic pressure value P (see FIG. 7) or the hydraulic pressure value of the caliper) of the hydraulic sensor 6a of the braking device 6 of the wheel 3 whose lock state is detected. As the hydraulic pressure value in the state in which the wheel 3 is locked becomes high, the road surface friction coefficient becomes high. Therefore, to be specific, a correlation between the hydraulic pressure value P and the road surface friction coefficient μ can be set as exemplified in FIG. 8. That is, in an example of FIG. 8, in a range in which the hydraulic pressure value P is not less than zero (0) and not more than a threshold value Pth (for instance, 10 [MPa]), the road surface friction coefficient μ can be calculated from the following expression.

μ=(1/Pth)×P (1)

In a range in which the hydraulic pressure value P is not less than the threshold value Pth, the road surface friction coefficient μ can be calculated from the following expression.

μ=1 (2)

In this way, according to the present embodiment, the road surface friction coefficient μ can be calculated from the detection result of the hydraulic sensor 6a in easier and faster ways.

Subsequently, the second collision determining unit 10e calculates a braking distance until the vehicle 1 travels straight from a current position and is stopped (step S144). The braking distance Lbm can be calculated from the following expression using, for instance, a current vehicle speed V, gravitational acceleration g, and the road surface friction coefficient μ obtained in step S143.

Lbm=V²/(2×g×μ) (3)

Then, the second collision determining unit 10e compares the separation distance Ld between the current vehicle 1 and the obstacle 20 with the braking distance Lbm (step S145). When braking distance Lbm is equal to or more than the separation distance Ld, the second collision determining unit 10e determines that a possibility of the vehicle 1 colliding with the obstacle 20 is high (high possibility).

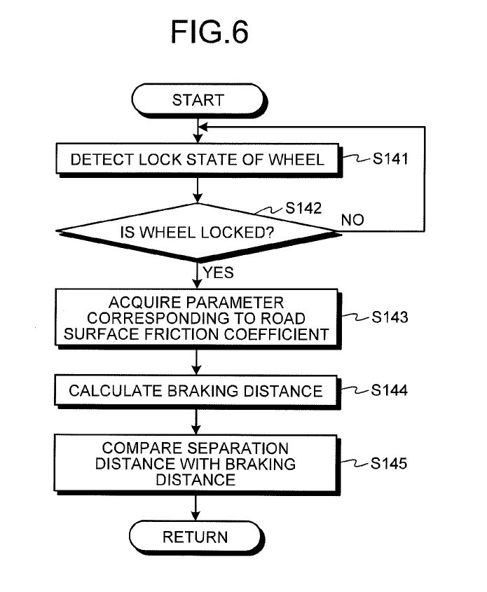

It can be understood that, referring to the time-dependent changes in the hydraulic pressure values of the front wheels 3FL and 3FR and the rear wheels 3RL and 3RR which are illustrated in FIG. 7, a rate of rise of the hydraulic pressure value until the rear wheels 3RL and 3RR are locked first is faster than that of the hydraulic pressure value until the front wheels 3FL and 3FR are locked first, that is, the rear wheels 3RL and 3RR (time t1) are locked at a faster rate than the front wheels 3FL and 3FR (time t2). This characteristic is attributed to a difference in an effective cross section area of the caliper. Thus, in the present embodiment, when this characteristic is used to determine the collision in step S14 of FIG. 3 (step S141 to step S145 of FIG. 6) associated with the aforementioned second collision determining unit 10e, the parameter (in the present embodiment, as an example, the detection result (hydraulic pressure value) of the hydraulic sensor 6a) corresponding to the wheel 3 (in the present embodiment, as an example, the rear wheels 3RL and 3RR) locked ahead is used, and thereby the collision is more rapidly determined. Here, the wheel 3 using the detection result does not need to be specified, and the parameter of the wheel 3 that is fastest locked among the multiple wheels 3 can be used. As a result of the earnest study of the inventors, there is no great variation in the road surface friction coefficient or the braking distance calculated (estimated) in the first lock state at each wheel 3, and there is no great difference between the calculated road surface friction coefficient and the road surface friction coefficient found from the deceleration obtained when all the wheels 3 are locked. The aforementioned collision determination turns out to be useful in terms of the rapidity. Further, the parameter corresponding to the road surface friction coefficient is not limited to the detection result of the hydraulic sensor 6a, and the road surface friction coefficient or the braking distance may be calculated from data (a table and a map) representing a function or a correlation on the basis of another parameter (for instance, a detection result (wheel speed) of the rotation sensor 5, a detection result (calculation result) of the vehicle speed, and the like) corresponding to the locked wheel 3. However, the use of the hydraulic pressure value is more effective for faster calculation. Further, in the present embodiment, the braking distance Lb calculated in step S11 and the braking distance Lbm calculated in step S14 may be different from each other. In addition, the road surface friction coefficient or the braking distance may also updated over time using the calculation result based on the parameter when each wheel 3 is locked.

Then, in step S145, when the braking distance Lbm is equal to or longer (greater) than the separation distance Ld (Yes in step S15, determined that the collision occurs (or that a chance to collide is present or high)), the control device 10 carries out step S16. On the other hand, when the braking distance Lbm is shorter (smaller) than the separation distance Ld (No in step S15, determined that no collision occurs (or that a chance to collide is not present or low)), the control device 10 continues four wheel braking up to several seconds after the vehicle is stopped (step S25), and then terminates a series of processes.

In step S16, the control device 10 functions as the side space detecting unit 10b, and determines whether or not a space S (see FIGS. 4 and 5) to which the vehicle 1 can move is present at the side of the obstacle 20 (step S16). In step S16, the control device 10 can, as an example, determine that a region where the obstacle 20 is not detected is the space S. In step S16, when the space to which the vehicle 1 can move is not present at the side of the obstacle 20 (No in step S16), the control device 10 continues four wheel braking up to several seconds after the vehicle is stopped (step S25), and then terminates a series of processes.

In step S16, when it is determined that the space S to which the vehicle 1 can move is present at the side of the obstacle 20 (Yes in step S16), the control device 10 functions as the detour path (position) calculating unit 10f, and calculates a detour path (position) for the obstacle 20 (step S17). Next, the control device 10 functions as the detour mode deciding unit 10g and the detour direction deciding unit 10h, and decides a detour mode and a detour direction (step S18).

With regard to step S18, as a result of the earnest study of the inventors, it is proved that, under given conditions, a movement distance Y (longitudinal axis) in a transverse direction relative to a forward/backward direction of the vehicle 1 and a vehicle speed V have a relation as exemplified in FIG. 9. In FIG. 9, a round mark indicates a transverse movement distance of the vehicle 1 when the vehicle makes a detour by causing the rear wheels 3RL and 3RR to be steered by the steering device 7 (or when each wheel 3 is braked), a square mark indicates a transverse movement distance of the vehicle 1 when the vehicle makes a detour by causing a difference in braking force to be generated at the left and right wheels 3 (the front wheels 3FL and 3FR and the rear wheels 3RL and 3RR) by the braking device 6 (or when the rear wheels 3RL and 3RR are not steered), and a rhombic mark indicates a transverse movement distance of the vehicle 1 when the rear wheels 3RL and 3RR are steered by the steering device 7 and when the vehicle makes a detour by causing a difference in braking force to be generated at the left and right wheels 3 (the front wheels 3FL and 3FR and the rear wheels 3RL and 3RR) by the braking device 6. It can be understood from FIG. 9 that the transverse movement distance when the rear wheels 3RL and 3RR are steered by the steering device 7 and when the vehicle is detoured by causing the difference in braking force to be generated at the left and right wheels 3 by the braking device 6 is greater than the transverse movement distance when the rear wheels 3RL and 3RR are steered by the steering device 7 or the transverse movement distance when the vehicle is detoured by causing the difference in braking force to be generated at the left and right wheels 3 by the braking device 6. Further, it is proved that, although not illustrated, a braking distance when the difference in braking force is generated at the left and right wheels 3 is easily increased compared to a braking distance when the vehicle is detoured by steering the rear wheels 3RL and 3RR through the steering device 7. This is because, when the difference in braking force is generated at the left and right wheels 3, the braking force is reduced at the wheels 3 located at a turning outer side (outer circumference side). Thus, in the present embodiment, the control device 10 is adapted to control each unit such that the vehicle 1 makes a detour (turn or collision avoidance) in a first detour mode in which the rear wheels 3RL and 3RR are steered by the steering device 7 and the front wheels 3FL and 3FR and the rear wheels 3RL and 3RR are also braked and a second detour mode in which the rear wheels 3RL and 3RR are steered by the steering device 7 and the difference in braking force is generated at the left and right wheels 3. The control device 10 selects the first detour mode when a small transverse movement distance is required, and the second detour mode when a greater transverse movement distance is required.

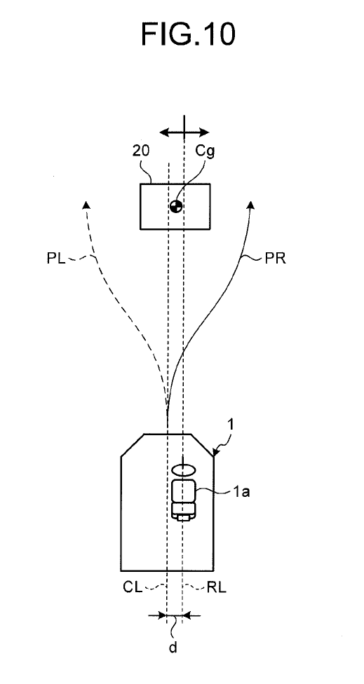

Further, with regard to step S18, as a result of the earnest study of the inventors, it is proved that a driver (operator) tends to grasp a relative position relation between the vehicle 1 and the obstacle 20 depending on a position of the obstacle 20 in a vehicle width direction (leftward/rightward direction of FIG. 10) of the vehicle 1 relative to a base line RL offset toward a driver's seat 1a by a given distance d rather than a position of the obstacle 20 in the vehicle width direction relative to a central line CL that extends through the vehicle width direction in a forward/backward direction (upward/downward direction of FIG. 10) of the vehicle 1. The base line RL is, for instance, a line that extends through the driver's seat 1a in the forward/backward direction of the vehicle 1. In an example of FIG. 10, the center Cg of the obstacle 20 in the vehicle width direction is located at the right side relative to the central line CL, but at the left side relative to the base line RL. In this case, since the center Cg of the obstacle 20 is located at the right side relative to the central line CL of the vehicle 1, the driver tends to recognize that, in spite of a state in which it is easier for a path PL making a detour to the left side to avoid the collision than for a path PR making a detour to the right side, it is easier for the path PR making a detour to the right side to avoid the collision than for the path PL making a detour to the left side. The detour path based on automatic control of the vehicle 1 caused by the control device 10 requests a premise of being able to detour the obstacle 20 as well as that it is easier for the driver to sensually accept the detour path. Thus, in the present embodiment, the control device 10 decides the detour direction according to a position of (the centroid or the center) of the obstacle 20 relative to the base line RL offset from the central line CL toward the driver's seat 1a on the assumption that the vehicle can detour the obstacle.

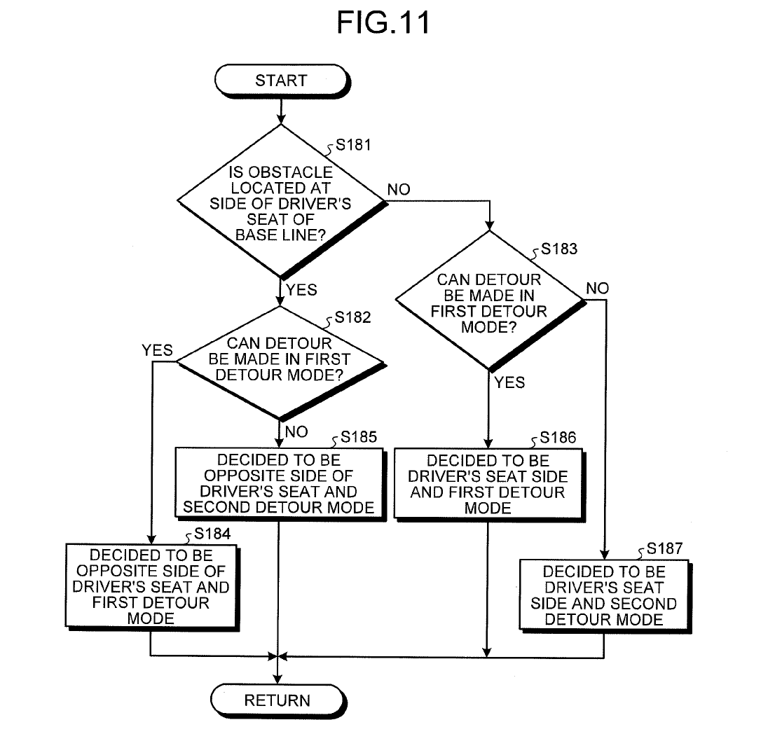

In step S18, the control device 10 can decide the detour mode and the detour direction, for instance, in a procedure exemplified in FIG. 11. As a premise of the procedure exemplified in FIG. 11, the control device 10 recognizes the relative position relation between the vehicle 1 and the obstacle 20, that is, the position of the obstacle 20 relative to the base line RL of the vehicle 1 from the detection result of the obstacle 20. Further, in step S17, the control device 10 calculates the detour path (position) with respect to each of a total of four patterns obtained by combination of two detour directions and two detour modes on the basis of the relative position relation between the vehicle 1 and the obstacle 20. In this case, the detour path may be calculated as one or more positions (or points, coordinates, passing positions). The control device 10 may calculate the detour path (position) using a known technique. Thus, the control device 10 can determine whether or not the vehicle 1 can detour the obstacle 20 in each of the four pattern according to the calculation in step S17. In the aforementioned state, when (the center Cg of) the obstacle 20 is located at the side (right side in the example of FIG. 10) of the driver's seat 1a of the base line RL (Yes in step S181), the process proceeds to step S182. In step S182, when the vehicle can make a detour in the first detour mode (Yes in step S182), the process proceeds to step S184. When the vehicle cannot make a detour in the first detour mode (No in step S182), the process proceeds to step S185. Further, when (the center Cg of) the obstacle 20 is not located at the side of the driver's seat 1a of the base line RL (No in step S181), the process proceeds to step S183. In step S183, when the vehicle can make a detour in the first detour mode (Yes in step S183), the process proceeds to step S186. When the vehicle cannot make a detour in the first detour mode (No in step S183), the process proceeds to step S187. In this way, when the obstacle 20 is located at one side of the base line RL, the detour direction deciding unit 10h decides the detour direction so as to make a detour to the other side. Thus, the detour mode deciding unit 10g decides the detour mode to be the first detour mode when the vehicle can make a detour in the first detour mode, and decides the detour mode to be the second detour mode when the vehicle cannot make a detour in the first detour mode.

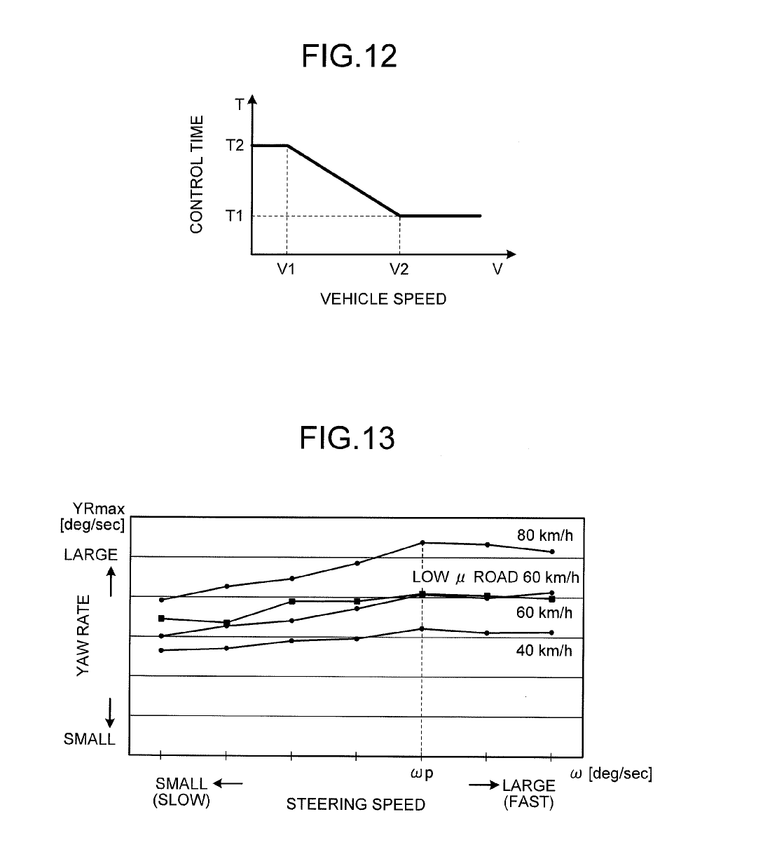

Next, the control device 10 functions as the vehicle behavior control unit 10i, and acquires a control time T (a time required to perform control, a control period, a control time length, or a control termination time) required to perform control of detour and deceleration based on next step S20 (step S19). In step S19, as an example, a table (data group) or a function from which the control time T corresponding to the vehicle speed V as illustrated in FIG. 12 is used. That is, the vehicle behavior control unit 10i acquires the control time T corresponding to the vehicle speed V based on the table or the function. As illustrated in FIG. 12, in the present embodiment, as an example, as the vehicle speed V becomes higher, the control time T is set to become shorter. This is because, as the vehicle speed V becomes higher, a time required to move from a current position P0 (see FIG. 5) to a position P1 (see FIG. 5) at which the obstacle 20 is detoured has only to be short. Further, in the present embodiment, as an example, the control time T may be set as a time required to move from a state in which the vehicle 1 travels along a lane set for a road (for instance, an expressway) at the vehicle speed V to the neighboring lane. As the vehicle speed V becomes higher, the time required to move between the lanes becomes shorter. As such, even in this case, the vehicle speed V and the control time T has a relation as illustrated in FIG. 12. Therefore, according to the present embodiment, as an example, after the collision with the obstacle 20 is avoided, the control for avoiding the collision with the obstacle 20 is easily inhibited from being vainly performed (continued) on the vehicle 1. Process step S19 is, as an example, carried out only at a first (or primary) timing, and not at secondary or subsequent timings of a loop of step S16 to step S22. Further, a position of the vehicle 1 which is becoming a source for calculating the control time T is not limited to that illustrated in FIG. 5. In addition, the vehicle behavior control unit 10i makes the control time T constant, and converts a steering angle or a steering speed depending on the vehicle speed V. Thereby, the vehicle behavior control unit 10i can adjust the movement distance of the vehicle 1. In this case, as an example, as the vehicle speed V becomes higher, the vehicle behavior control unit 10i reduces at least one of the steering angle and the steering speed. Further, the vehicle behavior control unit 10i may, as an example, convert the smaller of the steering angle and the steering speed along with the control time T depending on the vehicle speed V. In such control, the steering angle can be set as that relative to a steering angle when the control is initiated.

In step S20, the control device 10 functions (acts) as the vehicle behavior control unit 10i. As illustrated in FIG. 2, the braking control unit 10j, the steering control unit 10k, and the damping control unit 10m are included in the vehicle behavior control unit 10i. In step S20, the vehicle behavior control unit 10i controls each unit such that the vehicle 1 is decelerated while detouring the obstacle 20 in the decided detour mode and direction. To be specific, the vehicle behavior control unit 10i can function as at least one of the braking control unit 10j, the steering control unit 10k, and the damping control unit 10m such that yaw moment in a direction in which the obstacle 20 is detoured occurs at the vehicle 1. For example, as illustrated in FIG. 5, when the space S is detected at the right side of the obstacle 20, the vehicle behavior control unit 10i controls each unit such that rightward yaw moment occurs at the vehicle 1 at the outset of at least detour initiation. The vehicle behavior control unit 10i can switch (select) whether to function as any one of the braking control unit 10j, the steering control unit 10k, and the damping control unit 10m according to circumstances. Further, the vehicle behavior control unit 10i may be sequentially switched among the braking control unit 10j, the steering control unit 10k, and the damping control unit 10m and function (act) as such.

In step S20, as an example, the vehicle behavior control unit 10i (or the control device 10) functioning as the braking control unit 10j controls the braking system 61 (or the braking device 6) such that a braking force of the wheels 3 (front wheels 3FL and 3FR and the rear wheels 3RL and 3RR) located at the detouring (or turning) inner side (the right side in the example of FIG. 5) is greater (stronger) than that of the wheels 3 located at the detouring (or turning) outer side. Thereby, greater yaw moment is applied to the vehicle 1 in a detouring (or turning) direction, and the vehicle 1 may easily detour the obstacle 20.

Further, in step S20, as an example, the vehicle behavior control unit 10i (or the control device 10) functioning as the braking control unit 10j controls the braking system 61 (or the braking device 6) so as to become an operation different from when the vehicle 1 is stopped (decelerated) without a detour (when the vehicle 1 is stopped (decelerated) in the absence of a typical detour, when the vehicle 1 is stopped (decelerated) by an braking operation of a driver, or when the control of detour and deceleration of FIG. 3 is not performed). To be specific, in step S20, as an example, the vehicle behavior control unit 10i controls the braking system 61 such that the braking force of the wheel 3 is reduced, compared to when the vehicle 1 is stopped without a detour. Further, when the vehicle 1 is stopped without a detour, the braking system 61 (or the braking device 6) acts as ABS, and inhibits the wheel 3 from being locked. As such, multiple peaks of the braking force are generated at a time interval, and the braking force is changed intermittently (repetitively or periodically). In contrast, in step S20 regarding the control of the detour and deceleration, as an example, the vehicle behavior control unit 10i performs control to make the peak of the braking force smaller than when the vehicle 1 is stopped without a detour, to remove the peak of the braking force, to change (for example, reduce) the braking force more moderately (gradually) than when the vehicle 1 is stopped without a detour, or to make the braking force nearly constant. In this way, the operation of the braking system 61 (or the braking device 6) when the vehicle 1 is stopped without a detour is different from that when the control of the detour and deceleration is performed to avoid the obstacle 20. Therefore, according to the present embodiment, as an example, it is easy to control the behavior of the vehicle 1 in a more effective or reliable way.

Further, in step S20, as an example, the vehicle behavior control unit 10i (or the control device 10) functioning as the steering control unit 10k controls the steering device 7 (or the actuator 7a) such that the two rear wheels 3RL and 3RR are steered in a direction opposite to the detouring (turning) direction. Thereby, greater yaw moment is applied to the vehicle 1 in the detouring (turning) direction, and the vehicle 1 may detour the obstacle 20 with ease. Even under braking situation, the rear wheels 3RL and 3RR are rarely locked (slipped) compared to the front wheels 3FL and 3FR, and thus the steering of the rear wheels 3RL and 3RR contributes to detouring (turning) of the vehicle 1 in a more effective way. Therefore, in the present embodiment, as an example, the vehicle behavior control unit 10i (or the control device 10) functioning as the steering control unit 10k does not steer the front wheels 3FL and 3FR in order to turn the vehicle 1 with respect to the control of the detour and deceleration (automatic control for detouring the obstacle 20) of FIG. 3. That is, in the present embodiment, as an example, in the course of performing the control of the detour and deceleration of FIG. 3, the front wheels 3FL and 3FR are maintained in an unsteered state (at a neutral position or at a steering angle in the event of straight traveling).

With regard to the control in step S20, the inventors repeats an earnest study, and it is proved that turning performance is higher when the braking of the front wheels 3FL and 3FR, the braking of the rear wheels 3RL and 3RR, and the steering of the rear wheels 3RL and 3RR are properly combined and performed.

Furthermore, the inventors repeated an earnest study, and it is proved that, as illustrated in FIG. 13, a steering speed ωp (angular velocity) from which a peak of yaw moment (yaw rate) is obtained is present with respect to the steering of the rear wheels 3RL and 3RR. In FIG. 13, the transverse axis is a steering speed ω (deg/sec), and the longitudinal axis is a yaw rate YRmax (deg/sec). Further, FIG. 13 illustrates a relation between the steering speed ω and the yaw rate YRmax with respect to four vehicle speeds of 40 km/h, 60 km/h, 60 km/h (however, in a state in which the road surface friction coefficient μ is low), and 80 km/h. As apparent from FIG. 13, it is proved that, despite conditions such as a vehicle speed, the steering speed ωp from which the peak of the yaw moment is obtained is nearly constant. Therefore, in the present embodiment, as an example, the steering speed ω is set in the vicinity of the steering speed ωp from which the peak of the yaw moment is obtained and which is obtained by a test or simulation in advance.

Further, in step S20, as an example, the vehicle behavior control unit 10i (or the control device 10) functioning as the damping control unit 10m controls the suspension system 4 (or the shock absorber 4a and the actuator 4b) such that a damping force of the wheels 3 (the front wheels 3FL and 3FR and the rear wheels 3RL and 3RR) of the detouring (turning) outer side (the left side in the example of FIG. 5) is higher than that of the wheels 3 of the detouring (turning) inner side (the right side in the example of FIG. 5). Thereby, rolling (roll) of the vehicle 1 during the detouring (turning) is suppressed, and a grip force of the wheels 3 against the road surface is suppressed, so that the vehicle 1 may easily detour the obstacle 20. Further, the control over each unit caused by the vehicle behavior control unit 10i (or the control device 10) in step S20 may be variously changed. Further, the control may be changed over time depending on the position of the vehicle 1 or the detouring (turning) situation.

Further, the control device 10 function as the driver operation detecting unit 10c at any time (step S21). As described above, in the present embodiment, as an example, in the course of the control of the detour and the deceleration, the front wheels 3FL and 3FR are maintained at a neutral position without being steered. Therefore, in step S21, as an example, when a steering wheel is steered from the neutral position, the driver operation detecting unit 10c can detect steering as an operation of a driver. Thus, in step S21, when the operation of the driver is detected (Yes in step S21), the vehicle behavior control unit 10i is converted to the control of the detour and the deceleration, takes priority over the operation of the driver, and performs control corresponding to the operation of the driver (step S24). That is, in the present embodiment, as an example, when the operation of the driver (for example, the operation of the steering wheel by the driver or the steering of the front wheels 3FL and 3FR based on such an operation) is detected, the control (automatic control) of the detour and the deceleration is stopped. According to step S24, as an example, it is possible to inhibit control different from the operation of the driver from being carried out.

Further, in the case of No in step S21, as an example, if a time after the control of the detour and the deceleration is initiated does not exceed the control time T (No in step S22), the vehicle behavior control unit 10i (or the control device 10) returns to step S16.

On the other hand, as an example, if the time after the control of the detour and the deceleration is initiated is equal to or more than the control time T (Yes in step S22), the vehicle behavior control unit 10i (or the control device 10) performs control upon termination (step S23). In step S22, when the time after the control of the detour and the deceleration is less than (that is, does not exceed or is equal to) the control time T, the vehicle behavior control unit 10i returns to step S16. When the time after the control of the detour and the deceleration exceeds the control time T, the vehicle behavior control unit 10i may be set to transition to step S23.

In step S23, when the control of the detour and the deceleration is terminated, the vehicle behavior control unit 10i performs control (control upon termination or stabilizing control) to be in a state in which the vehicle 1 can travel in a more stable way after the termination of the control. As an example, the vehicle behavior control unit 10i controls the steering device 7 (or the actuator 7a) such that the steering angle of the wheels 3 (or the rear wheels 3RL and 3RR) becomes zero (0) or the yaw moment becomes zero (0).

As described above, in the present embodiment, as an example, the detour mode deciding unit 10g is decided to be any of the first detour mode and the second detour mode. Therefore, as an example, the collision or contact with the obstacle 20 is more effectively avoided with ease using the first detour mode in which the braking distance is relatively short and the second detour mode in which the transverse movement distance is greater.

Further, in the present embodiment, as an example, the detour mode deciding unit 10g selects any one of the first detour mode and the second detour mode based on the detection result of the traveling state of the vehicle 1. Therefore, as an example, the collision or contact with the obstacle 20 is more effectively avoided with ease by selection of the detour mode corresponding to situations.

Further, in the present embodiment, as an example, when the vehicle cannot detour the obstacle 20 on the path (position) according to the first detour mode calculated by the detour path (position) calculating unit 10f, the control according to the second detour mode is performed. Therefore, as an example, the first detour mode in which the braking distance is further shortened is preferentially selected, and thus the braking distance is further shortened with ease.

Further, in the present embodiment, as an example, when the obstacle 20 is located at one side relative to the base line RL offset from the central line CL, which extends through the vehicle width direction center of the vehicle 1 in the forward/backward direction of the vehicle 1, toward the driver's seat 1a by a given distance d, the detour direction deciding unit 10h controls the vehicle 1 to detour the obstacle 20 to the other side. Therefore, as an example, the vehicle 1 easily makes a detour in a direction accepted in an easier way by a driver.

For example, the present invention also includes a configuration in which the control over the collision avoidance caused by the deceleration or the detour is performed based on the detection result of the obstacle in front of the vehicle in the state in which the vehicle is not braked.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle behavior control device comprising:
a collision determining unit configured to determine whether or not a vehicle collides with an obstacle at a time the vehicle is decelerated while traveling straight, based on a detection result of the obstacle in front of the vehicle and a detection result of a traveling state of the vehicle, in a state in which wheels are braked; and
a vehicle behavior control unit configured to perform any of a first detour mode in which control over steering of rear wheels is performed and control of providing a difference in a braking state of left and right wheels is not performed and a second detour mode in which the control over steering of the rear wheels and the control of providing the difference in the braking state of the left and right wheels are performed such that the vehicle is decelerated while detouring the obstacle, at a time it is determined by the collision determining unit that the vehicle collides with the obstacle.

2. The vehicle behavior control device according to claim 1, wherein
the vehicle behavior control unit selects and performs any one of the first detour mode and the second detour mode based on the detection result of the traveling state of the vehicle.

3. The vehicle behavior control device according to claim 1, further comprising:
a detour path calculating unit configured to calculate a path of the vehicle at a time the vehicle is decelerated while detouring the obstacle, wherein
the vehicle behavior control unit performs control according to the second detour mode when the vehicle does not detour the obstacle on a path that is calculated by the detour path calculating unit and is caused by the first detour mode.

4. The vehicle behavior control device according to claim 1, wherein
at a time the detected obstacle is located at one side relative to a base line offset from a central line, which extends through a vehicle width direction center of the vehicle in a forward/backward direction of the vehicle, toward a driver's seat by a given distance, the vehicle behavior control unit controls the vehicle to detour the obstacle to the other side, and
at a time the detected obstacle is located at the other side relative to the base line, the vehicle behavior control unit controls the vehicle to detour the obstacle to one side.

5. The vehicle behavior control device according to claim 2, wherein
at a time the detected obstacle is located at one side relative to a base line offset from a central line, which extends through a vehicle width direction center of the vehicle in a forward/backward direction of the vehicle, toward a driver's seat by a given distance, the vehicle behavior control unit controls the vehicle to detour the obstacle to the other side, and
at a time the detected obstacle is located at the other side relative to the base line, the vehicle behavior control unit controls the vehicle to detour the obstacle to one side.

6. The vehicle behavior control device according to claim 3, wherein
at a time the detected obstacle is located at one side relative to a base line offset from a central line, which extends through a vehicle width direction center of the vehicle in a forward/backward direction of the vehicle, toward a driver's seat by a given distance, the vehicle behavior control unit controls the vehicle to detour the obstacle to the other side, and
at a time the detected obstacle is located at the other side relative to the base line, the vehicle behavior control unit controls the vehicle to detour the obstacle to one side.

7. A vehicle behavior control system comprising:
a data acquiring unit configured to acquire underlying data for detecting an obstacle in front of a vehicle;
a steering device for rear wheels;
a braking device for each wheel; and
a control device configured to have a collision determining unit that determines whether or not the vehicle collides with the obstacle at a time the vehicle is decelerated while traveling straight, based on a detection result of the obstacle in front of the vehicle and a detection result of a traveling state of the vehicle, in a state in which the wheels are braked, and a vehicle behavior control unit that performs any of a first detour mode in which control over steering of the rear wheels is performed and control of providing a difference in a braking state of left and right wheels is not performed and a second detour mode in which the control over steering of the rear wheels and the control of providing the difference in the braking state of the left and right wheels are performed such that the vehicle is decelerated while detouring the obstacle, at a time it is determined by the collision determining unit that the vehicle collides with the obstacle.
